(19) United States
(12) Patent Application Publication
(10) Pub. No.: US 2016/0328811 A1
(43) Pub. Date: Nov. 10, 2016

(54) ASSET RIGHTS CLEARANCE

(71) Applicant: Fadel Partners, Inc., Rye, NY (US)

(72) Inventors: Gregory P. Guest, Yonkers, NY (US); Walid A. El Daccache, New Rochelle, NY (US); Tarek E. Fadel, Rye, NY (US); David Marc Feuerstein, Murrieta, CA (US)

(21) Appl. No.: 14/703,742

(22) Filed: May 4, 2015

(51) Int. Cl. G06Q 50/18; G06F 17/30

(52) U.S. Cl. CPC G06Q 50/184; G06F 17/30864

(57) ABSTRACT

A method for asset rights clearance may include receiving an asset clearance query associated with an asset. The asset clearance query may inquire a use of the asset in one or more manners. The method may include sending the asset clearance query to a cloud-based rights clearance server. The method may additionally include receiving a response from the cloud-based rights clearance server. The method may additionally include determining that the response includes an indication of an availability to use the asset in a first manner of the one or more manners. The method may additionally include presenting the indication of the availability to use the asset in the first manner.

### FIELD

Some embodiments described herein generally relate to asset rights clearance.

### BACKGROUND

Unless otherwise indicated herein, the materials described herein are not prior art to the claims in the present application and are not admitted to be prior art by inclusion in this section.

In a multimedia driven world of entertainment, media companies and/or content providers may face challenges related to clearing rights for intellectual property (IP) based assets in order to maximize revenue and exploit emerging digital distribution channels and platforms. With a multitude of partners and license agreements associated with a piece of IP assets, it may be difficult to obtain fast and/or real-time answers to asset availability and rights clearance. In addition, an organization may have multiple lines of business or departments associated with a rights clearance process. For example, individuals in a sales department, an editorial department, a finance department, and/or a brand assurance department may need to access rights clearance information, as well as enterprise systems (e.g., digital asset management (DAM), contract management system (CMS), etc.) which may also need rights data to determine asset availability and/or provide real-time asset clearance.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to asset rights clearance.

In an example embodiment, a method for asset rights clearance may include receiving an asset clearance query associated with an asset. The asset clearance query may inquire a use of the asset in one or more manners. The method may include sending the asset clearance query to a cloud-based rights clearance server. The method may additionally include receiving a response from the cloud-based rights clearance server. The method may additionally include determining that the response includes an indication of an availability to use the asset in a first manner of the one or more manners. The method may additionally include presenting the indication of the availability to use the asset in the first manner.

In another example embodiment, a method for asset rights clearance may include receiving an asset clearance query associated with an asset from a client device or another software system, such as a content management system, digital/media asset management system or media distribution systems. The asset clearance query may inquire a use of the asset in one or more manners. The method may include querying an asset registry using the asset clearance query to determine an availability to use the asset in a first manner of the one or more manners. The method may additionally include sending a response that includes an indication of the availability to use the asset in the first manner.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment that includes a rights clearance server and one or more client devices configured to manage asset rights clearance;

FIG. 2A is a graphic representation that illustrates an example asset header page and asset subsection menu;

FIG. 2B is a graphic representation that illustrates example available rights for an asset;

FIG. 2C is a graphic representation that illustrates an example restricted right for the asset of FIG. 2B;

FIG. 2D is a graphic representation that illustrates an example global rule for an asset type;

FIG. 3A is a flow diagram of an example method of performing asset rights clearance for an asset on a client side;

FIG. 3B is a flow diagram of an example method of performing asset rights clearance for an asset on a server side;

FIG. 4A is a flow diagram of an example method of performing a rights query on a client side;

FIG. 4B is a flow diagram of an example method of performing a rights query on a server side;

FIG. 4C is a graphic representation that illustrates an example response that includes an asset that satisfies a rights condition;

FIG. 5 is a block diagram that illustrates an example computing device that is arranged to perform asset rights clearance;

FIGS. 6A-6F are graphic representations that illustrate various example user interfaces for managing assets and/or performing asset rights clearance;

FIG. 7A is a graphic representation that illustrates an example user interface for configuring an example asset rights clearance query;

FIG. 7B is a graphic representation that illustrates an example user interface that shows an example clearance result;

FIG. 7C is a graphic representation that illustrates an example clearance pop-up that shows exclusions of FIG. 7B; and

FIG. 7D is a graphic representation that illustrates an integrated widget example of asset rights clearance.

### DETAILED DESCRIPTION OF SOME EXAMPLE EMBODIMENTS

Embodiments described herein generally relate to asset rights clearance.

Some systems and/or applications may provide a contract-centric view of rights data. For example, contract data may include payments, guarantees to royalty rates, deliverable dates, and/or other information. Some embodiments described herein may provide an asset-centric view of rights data. For example, technologies described herein may provide real-time cloud-based rights clearance at an asset level via manual access and/or web service calls. Technologies described herein may be configured to upload asset data and/or rights data to a cloud server, analyze the asset data and/or the rights data, run rights queries to obtain asset rights clearance, and/or perform rights analytics in near real time. Alternatively or additionally, technologies described herein may be designed to service enterprise systems (e.g., a digital asset repository, a contract management system) by providing web services that may be used to ingest rights data, provide rights clearance, and/or present asset data.

In some embodiments, technologies described herein may be implemented with cloud-based techniques to provide manual or automated access to asset rights clearance. Alternatively or additionally, technologies described herein may also be deployed on premise or integrated in third-party products to provide real-time automated rights clearance.

Reference will now be made to the drawings to describe various aspects of some example embodiments of the invention. The drawings are diagrammatic and schematic representations of such example embodiments, and are not limiting of the present invention, nor are they necessarily drawn to scale.

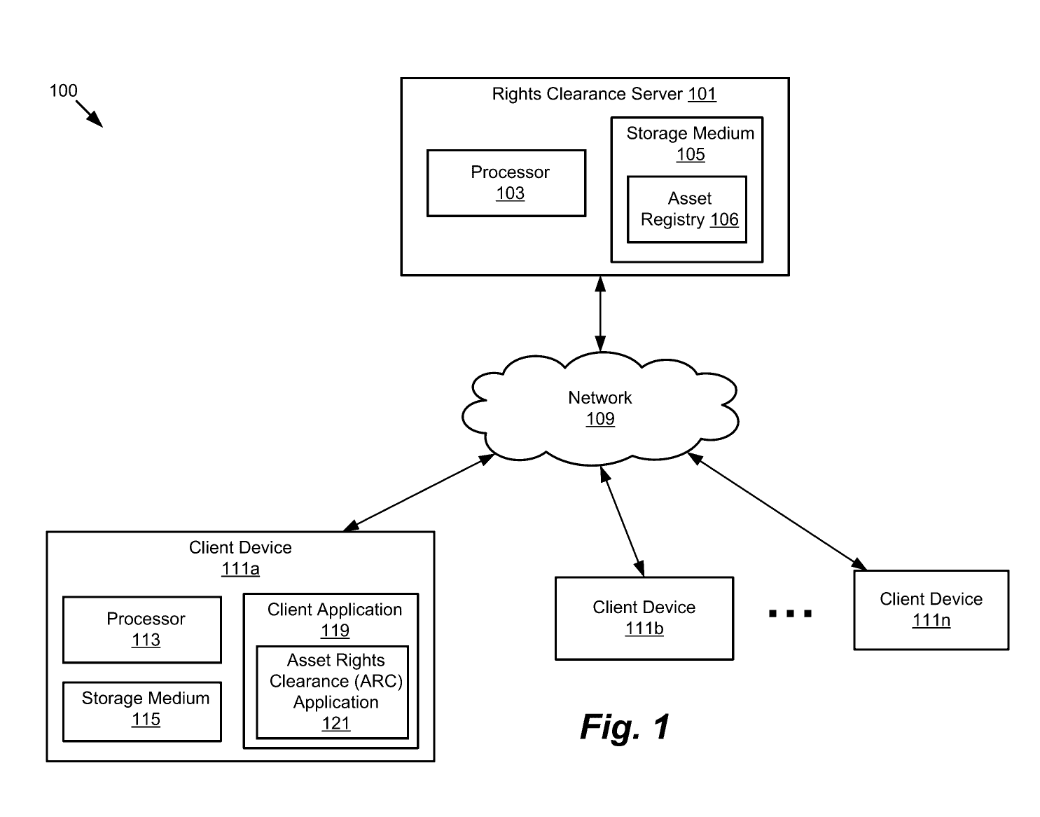

FIG. 1 is a block diagram of an example operating environment 100 that includes a rights clearance server 101 and client devices 111a, 111b . . . 111n (also referred to collectively or individually as client device 111), arranged in accordance with at least some embodiments described herein. Although one rights clearance server 101 and three client devices 111a, 111b, 111n are illustrated in FIG. 1, the operating environment 100 may more generally include any number of web servers 101 and/or any number of client devices 111. In these and other embodiments, the operating environment 100 may include other servers and/or devices not illustrated in FIG. 1, such as an asset hosting server or other devices.

The operating environment 100 may additionally include a network 109. In general, the network 109 may include one or more wide area networks (WANs) and/or local area networks (LANs) that enable the rights clearance server 101 and the client devices 111 to communicate with each other. In some embodiments, the network 109 may include the Internet, including a global internetwork formed by logical and physical connections between multiple WANs and/or LANs. Alternately or additionally, the network 109 may include one or more cellular radio frequency (RF) networks and/or one or more wired and/or wireless networks such as, but not limited to, 802.xx networks, Bluetooth access points, wireless access points, Internet Protocol (IP)-based networks, or the like. The network 109 may also include servers that enable one type of network to interface with another type of network.

In general, the rights clearance server 101 may receive queries from the client devices 111 and may return corresponding responses to the client devices 111. The rights clearance server 101 may include a processor 103, a storage medium 105, and other suitable components. The processor 103 may be of any type including, but not limited to, a central processing unit (CPU), a microprocessor (IP), a microcontroller (LIC), a digital signal processor (DSP), or any combination thereof. The processor 103 may be configured to execute computer instructions that, when executed, cause the processor 103 to perform one or more of the operations described herein with respect to the rights clearance server 101.

The storage medium 105 may include non-transitory volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 105 may store computer instructions that may be executed by the processor 103 to perform one or more of the operations described herein with respect to the rights clearance server 101.

The storage medium 105 may store an asset registry 106 and/or other suitable information. The asset registry 106 may include information related to various assets. For example, for each asset, the asset registry 106 may include asset header information, asset details, asset rights (e.g., available rights, restricted rights, inherited rights), and/or other suitable information associated with the asset such as asset meta-data. The asset registry 106 may also include global rules applied to different types of assets. In some embodiments, different assets may be uploaded to the rights clearance server 101, analyzed by the rights clearance server 101, and stored in the storage medium 105. Alternatively or additionally, rights data associated with the assets may be uploaded to the rights clearance server 101 and analyzed by the rights clearance server 101. The rights data may be associated with corresponding assets and stored in the storage medium 105.

Each of the client devices 111 may include, but is not limited to, a desktop computer, a laptop computer, a tablet computer, a mobile phone, a smartphone, a personal digital assistant (PDA), a wearable device (e.g., a smart watch), or another suitable client device. Each of the client devices 111 may additionally include a processor and a storage medium, such as a processor 113 and a storage medium 115 as illustrated for the client device 111a. Each of the client devices 111 may be similarly configured.

The processor 113 may be of any type including, but not limited to, a CPU, a μP, a μC, a DSP, or any combination thereof. The processor 113 may be configured to execute computer instructions that, when executed, cause the processor 113 to perform one or more of the operations described herein with respect to the client device 111a and/or an asset rights clearance (ARC) application 121.

The storage medium 115 may include non-transitory volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 115 may store computer instructions that may be executed by the processor 113 to perform one or more of the operations described herein with respect to the client device 111a and/or the ARC application 121.

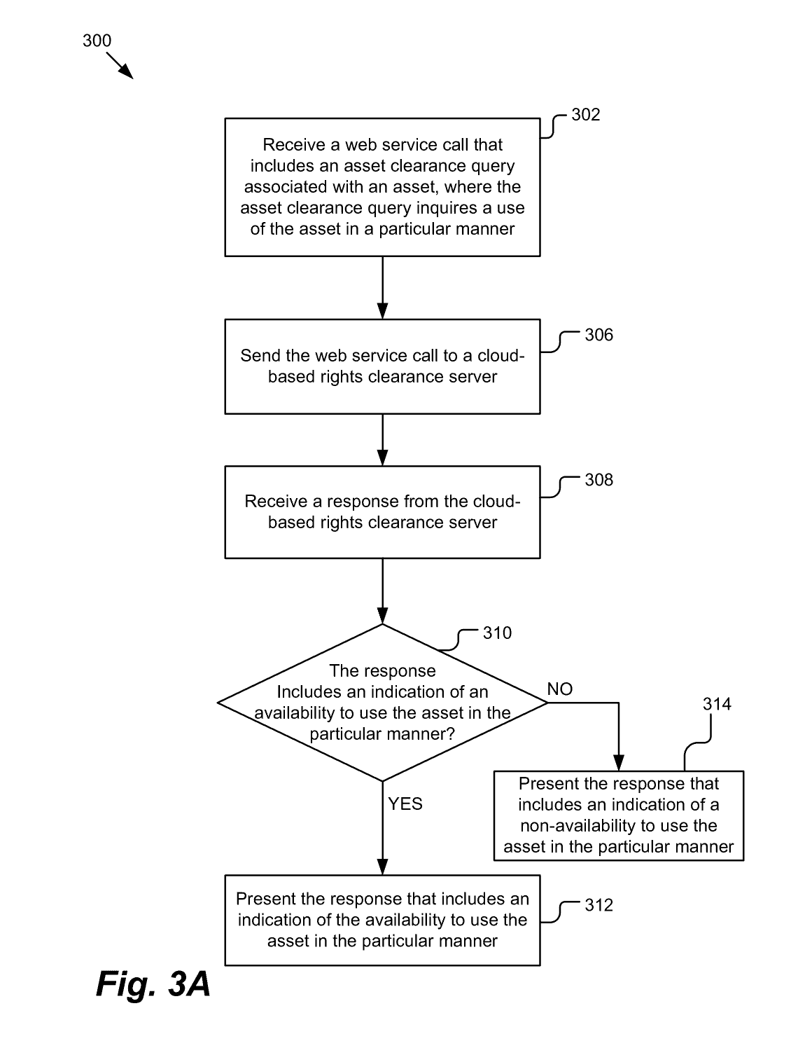

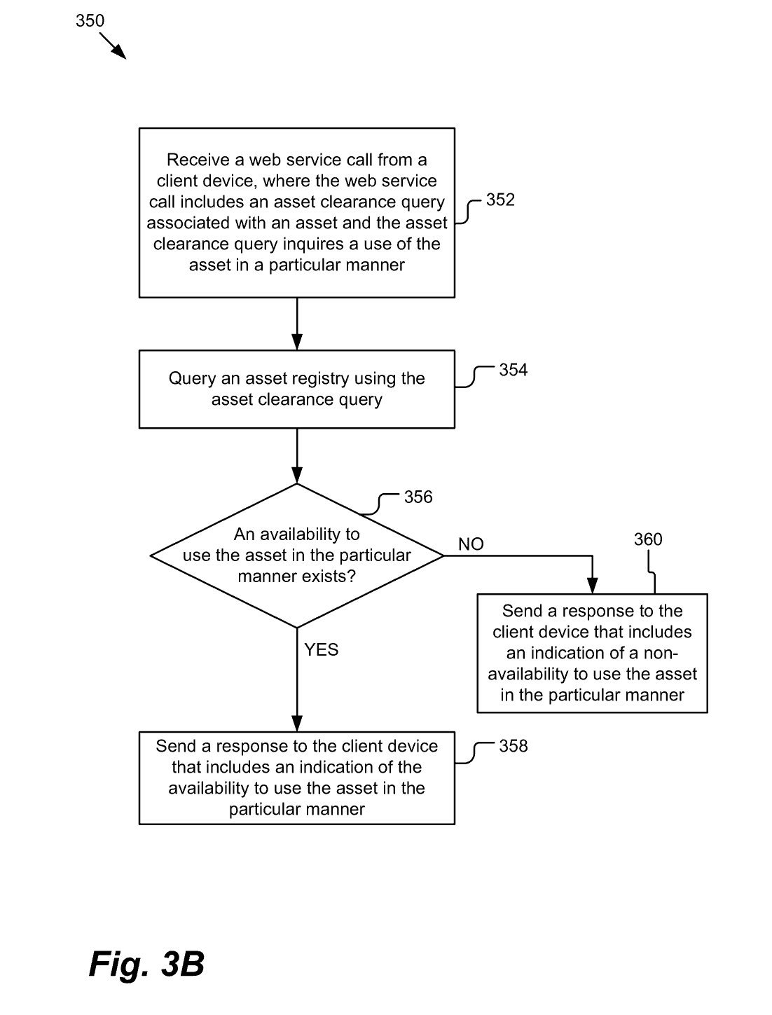

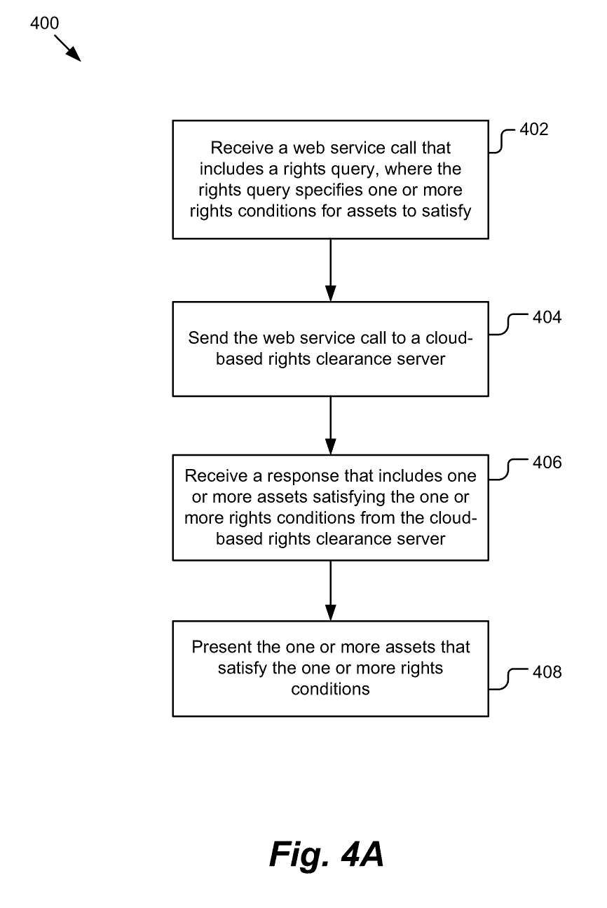

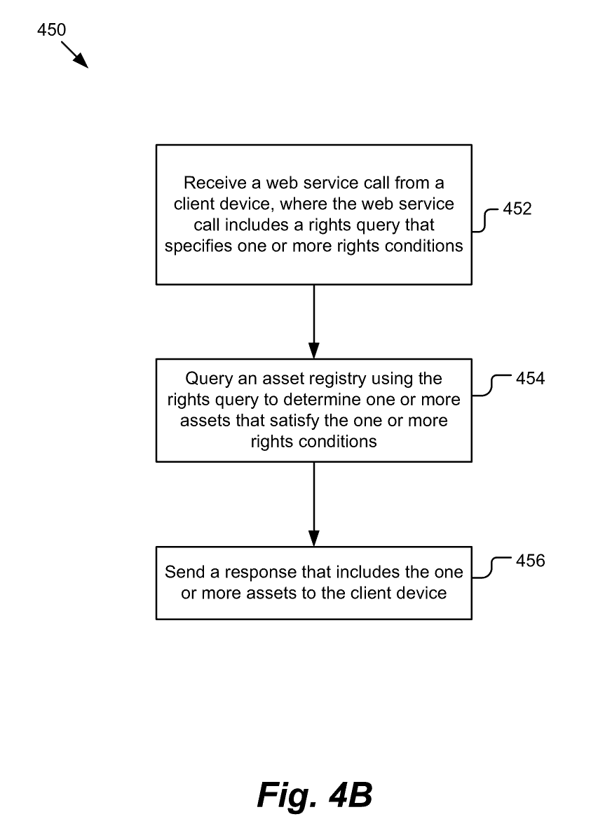

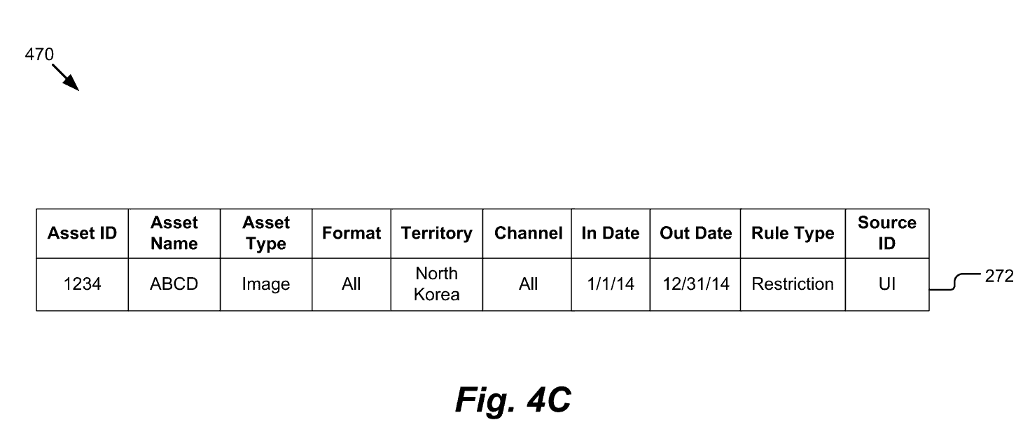

Each of the client devices 111 may execute an ARC application (e.g., the ARC application 121), configured to communicate through the network 109 with the rights clearance server 101. The ARC application 121 may be embedded in a client application 119 stored on the client device 111a. In some embodiments, the ARC application 121 may be implemented as software. Alternatively or additionally, the ARC application 121 may be implemented using hardware or a combination of software and hardware. The ARC application 121 may be configured as a plug in to the client application 119. In some embodiments, the ARC application 121 may be configured to perform operations similar to those described below with reference to FIGS. 3A and 4A.

The client application 119 may include, but is not limited to, a DAM system, a media asset management (MAM) system, a CMS system, a sales system, a media distribution service system, or other suitable systems. The client application 119 may include a third-party software application or a hardware system. The client application 119 may use a series of web services to issue web service calls to the ARC application 121, causing the ARC application 121 to obtain rights clearance information from the rights clearance server 101 and then forward the rights clearance information to the client application 119. The web service calls may include corresponding queries for the rights clearance information.

Each of the client devices 111 may additionally include or be coupled to one or more input and/or output (I/O) devices, such as a display, a touchscreen display, a keyboard, a microphone, a speaker, or other I/O device. The I/O devices may output information to users, such as information about assets and/or asset rights clearance user interfaces, and may receive input from users to, e.g., generate user queries regarding asset rights.

In some embodiments, the rights clearance server 101 and the ARC application 121 may be implemented using a cloud-based architecture. A user may launch the ARC application 121 on the client device 111 and may use the ARC application 121 to access the rights clearance server 101 via the network 109. The ARC application 121 may cooperate with the rights clearance server 101 to provide a user interface for accessing asset data, rights data, and/or other rights analytics tools. Alternatively or additionally, the rights clearance server 101 and the ARC application 121 may be integrated into a single entity.

In some embodiments, the ARC application 121 may provide a user interface (e.g., a dashboard) to a user when the user logs in. The dashboard may include, but is not limited to: login information (e.g., a user name, a last login time, a role of the user); a navigation menu with access to assets, rights analytics, global rules, and/or administration tasks; a workflow task list; announcements (e.g., new assets available, recent exclusion indicated by global rules, assets added recently, etc.); asset highlights (e.g., top requested assets, used or unused assets, charts and/or statistics about assets, etc.); a help link; and other information.

From the dashboard, the user may navigate to an asset overview page that may provide access to an asset registry and other tools for finding and viewing asset details. The asset overview page may include, but is not limited to: the asset registry that may provide a list view of all available assets; a search section that may be used to search for assets based on an asset identifier (ID), an asset type, an asset status, and/or other asset metadata; search results that may include asset IDs, asset types, asset statuses, other asset metadata, links to asset headers and/or details, and/or other asset information.

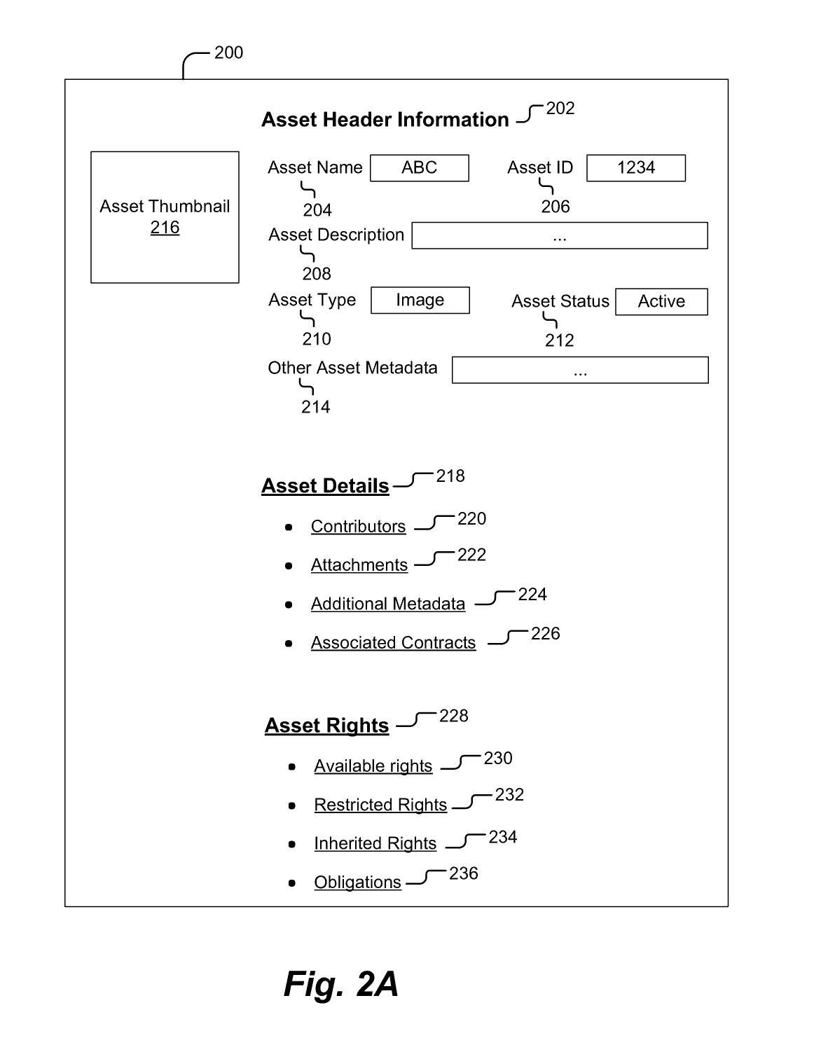

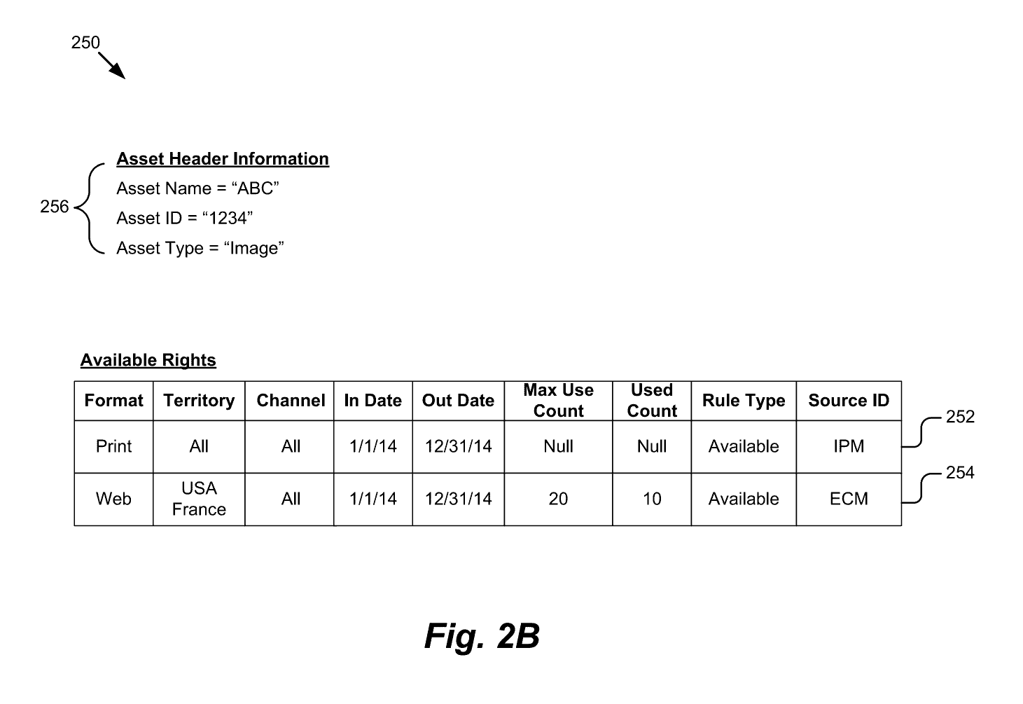

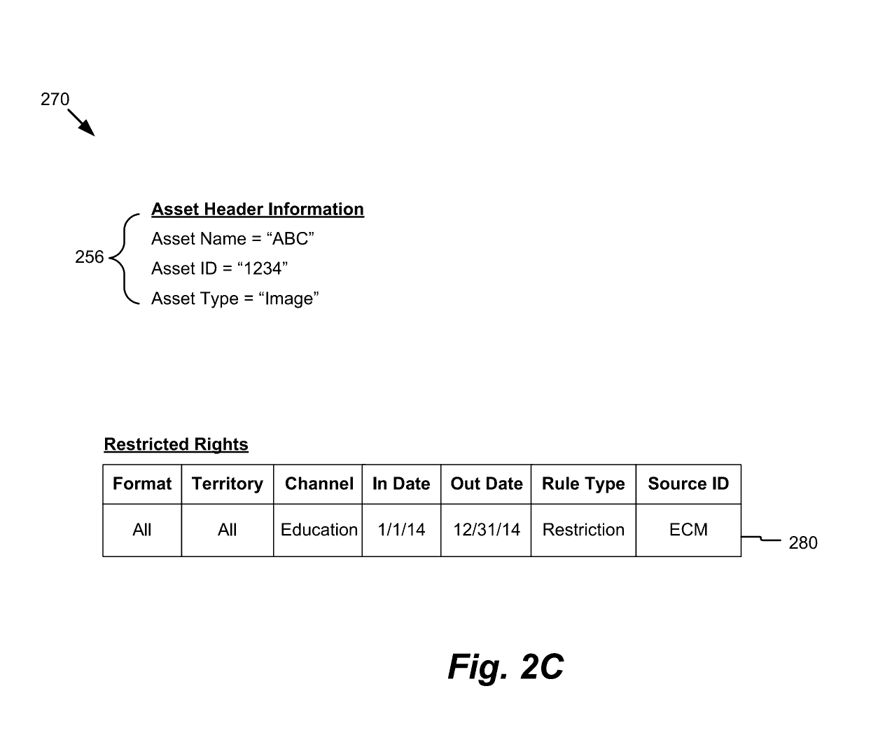

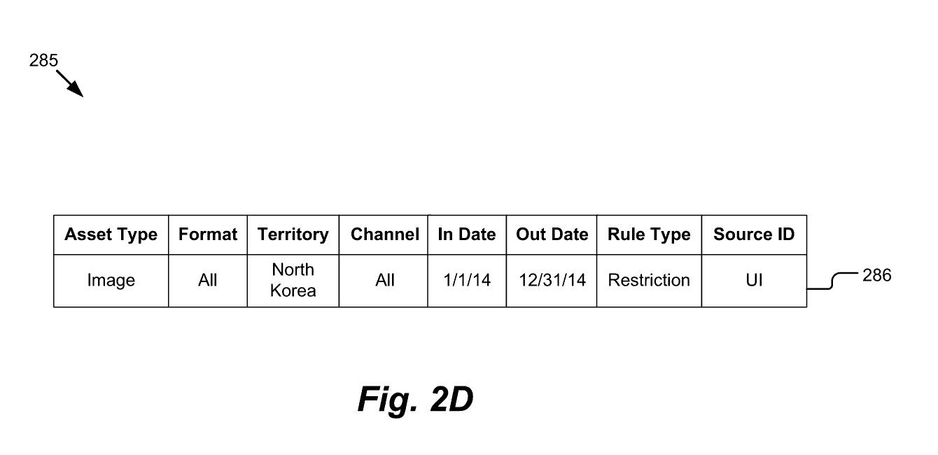

From the asset overview page, the user may search for and/or locate an asset to review. The user may access an asset header page that may display header level information associated with the asset. The asset header page may provide access to asset details and other asset information. An example asset header page 200 is illustrated in FIG. 2A. Referring to FIG. 2A, the asset header page 200 may include asset header information 202, an asset thumbnail image 216, links and/or tabs for asset details 218, and links and/or tabs for asset rights 228. The asset header information 202 may include an asset name 204, an asset ID 206, an asset description 208, an asset type 210 (e.g., image, video, sound track, printed books, e-books, etc.), an asset status 212 (e.g., active, or inactive), and other asset metadata 214.

The asset details 218 may include contributors 220, attachments 222, additional metadata 224, and/or associated contracts 226. From the asset header page 200, the user may navigate to an asset details page that may display details of the contributors 220, the attachments 222, the additional metadata 224, and/or the associated contracts 226.

The contributors 220 associated with the asset may include individuals or parties that may have made contribution to the asset. For example, the contributors 220 may include writers, producers, artists, photographers, models, content owners, content creators, or other individuals or parties. In some embodiments, there may be one or more obligations related to a particular contributor. The one or more obligations may include a payment, an acknowledgement of contribution, and/or other types of obligations. A right to use the asset in a particular manner may be available if the one or more obligations are fulfilled. For example, a photo may be used in a web publication if $500 is paid to a photographer that took the photo or a credit to the photographer is included in the web publication (e.g., an acknowledgement of the photographer's contribution is included). In some embodiments, the one or more obligations may be tied to the contributors 220 and may be provided under a section for the asset rights 228.

Information related to a contributor may include the contributor's name, the contributor's role in the asset (e.g., a creator, distributor, etc.), an in date (e.g., a start date when the asset may be associated with the contributor), an out date (e.g., a date when an association between the asset and the contributor may be terminated), and/or the contributor's contact information (e.g., a phone number, an email address, etc.).

The attachments 222 may include various types of attachments. Information related to an attachment may include an attachment type (e.g., a file, a uniform resource locator (URL), a note, etc.), a file type, an attachment name, an attachment description, an upload date, a creator, and/or other information. The asset details page provided herein may include an attachment tab that allows the user to upload documents (e.g., a contract, a document including creator information, or other documents) to be attached to an asset record. Alternatively or additionally, a web URL link or a descriptive note may be accepted as an attachment to the asset.

The asset details page may also include an additional metadata tab that may include additional metadata fields. An additional metadata field may include, but is not limited to, a field type, a field name, a field description, an asset type that indicates which type of assets the additional metadata field appears on, a grouping according to asset types, a field order that indicates where the additional metadata field appears in the asset details page, and/or other field information. In some embodiments, the additional metadata fields may be set up or managed via an administration area.

The asset rights 228 may include available rights 230, restricted rights 232, inherited rights 234, and obligations 236. In some embodiments, the user may access an asset rights page from the header information page 200 by clicking on the asset rights 228. The asset rights page may include detail information related to the available rights 230, the restricted rights 232, the inherited rights 234, and the obligations 236 of the asset.

The available rights 230 and/or the restricted rights 232 may be defined at an asset level for a particular asset. The inherited rights 234 may include rights inherited from one or more global rules. The inherited rights 234 and/or the global rules may be defined at a system level and may be applicable to all assets that may satisfy the global rules. For example, a global rule may be applicable to an asset type of images such that all image assets may inherit an inherited right determined by the global rule.

Each right (e.g., an available right, a restricted right, or an inherited right) associated with an asset may be defined by one or more rights attributes, an in date, an out date, a rule type, a source ID, and/or other fields. An in date may indicate a start date when the right may be valid. An out date may indicate an end date when the right may become invalid. The in date and the out date may determine a particular time frame during which the right may be valid or effective. A rule type may include an available type for an available right or a restriction type for a restricted right. A source ID may identify a source of the right.

Each right may be defined across a series of rights attributes (e.g., 5 rights attributes or another suitable number of rights attributes). The rights attributes may be configured to represent various pieces of rights data including, but not limited to, territory, media format, distribution channel, sales type, language, and/or other suitable attributes. The rights attributes may be dynamic and different asset types may be associated with different rights attributes. For example, a rights attribute “language” may be used to configure a right for an audio file asset, while a rights attribute “format” may be used to configure a right for a text-based document asset.

Each rights attribute may be configured using a hierarchical structure and may include multiple values for the rights attribute organized as branches or nodes in the hierarchical structure. For example, a hierarchical structure for a rights attribute “format” (e.g., “format->print->hardcover” and “format->digital->web site”) may include a parent node “format,” a first child node “print” connected to the parent node “format,” a first grandchild node “hardcover” connected to the first child node “print,” a second child node “digital” connected to the parent node “format,” and a second grandchild node “web site” connected to the second child node “digital.” In some embodiments, a hierarchical structure may include a pure parent/child relationship. Alternatively, the hierarchical structure may include a networked relationship where different parent nodes may include a common child node. Hierarchical structures for different rights attributes and values in the hierarchical structures may be pre-configured and pre-defined according to asset types. Values for the rights attributes may be accessible to users, so that users may associate the values with a particular asset or a particular asset type to define a right for the particular asset or the particular asset type.

In some embodiments, an available right may be described by one or more values of one or more rights attributes, an in date, an out date, a max use count, a used count, a rule type, a source ID, and/or other fields. A max use count may indicate a maximum number of times that the asset can be used in a particular manner according to the available right. A used count may indicate a number of times that the asset may be already used in the particular manner. The rule type may include an “available” type for the available right. An example of available rights for an image asset is illustrated in FIG. 2B.

In some embodiments, a restricted right may be described by one or more values of one or more rights attributes, an in date, an out date, a rule type, a source ID, and/or other fields. The rule type may include a restriction type for the restricted right. An example of a restricted right for an image asset is illustrated in FIG. 2C.

In some embodiments, an inherited right may be determined from a global rule. The global rule may be described by an asset type, one or more values of one or more rights attributes, an in date, an out date, a rule type, a source ID, and/or other fields. The rule type for the global rule may include an “available” type if the global rule may be used to define an available right for assets in the asset type. Alternatively, the rule type for the global rule may include a “restriction” type if the global rule may be used to define a restricted right for assets in the asset type. The asset type may determine a type of assets that the global rule may be applied to. An example of a global rule for image assets is illustrated in FIG. 2D. A user may access a global rule page from the dashboard. The global rule page may provide access to and/or allow searches for global rule details according to an asset type, one or more rights attributes, a rule type, a source ID, and/or other search criteria. Global rules may be set up via an administration section.

FIG. 2B is a graphic representation 250 that illustrates example available rights for an image asset 256, arranged in accordance with at least some embodiments described herein. By way of example, three rights attributes may be selected to define available rights for image assets. The rights attributes may include: a rights attribute “format” with possible values of “print” and “web” (and/or other format values); a rights attribute “territory” with possible values of “USA,” “Canada,” “Mexico,” “France,” and “North Korea” (and/or other territory values); and a rights attribute “channel” with possible values of “retail” and “education” (and/or other channel values). In other examples, other rights attributes and/or other values for the rights attributes may be determined for the image assets.

Turning to FIG. 2B, for the image asset 256 with an asset name “ABC,” an asset ID “1234,” and an asset type “image,” one or more rights available to the image asset 256 may be defined by one or more different combinations of values associated with the rights attributes. For example, the image asset 256 may be associated with a first available right illustrated in a row 252 (e.g., print rights are available for the image asset 256 worldwide via all channels). The first available right may be associated with an in date of Jan. 1, 2014, an out date of Dec. 31, 2014, no limit on a max use count, an “available” rule type, and a source ID “IPM.” The in date and/or the out date may be determined using a universal timestamp (e.g., hour:minute such as 03:10).

The image asset 256 may also be associated with a second available right illustrated in a row 254 (e.g., web publication rights are available for the image asset 256 in USA and France only via all channels). The second available right may be associated with an in date of Jan. 1, 2014, an out date of Dec. 31, 2014, a max use count of 20, a used count of 10, an “available” rule type, and a source ID “ECM.”

FIG. 2C is a graphic representation 270 that illustrates an example restricted right for the image asset 256 of FIG. 2B, arranged in accordance with at least some embodiments described herein. By way of example, the image asset 256 may be additionally associated with a restricted right illustrated in a row 280 (e.g., the image asset 256 may not be used in educational channels).

FIG. 2D is a graphic representation 285 that illustrates an example global rule for an image asset type, arranged in accordance with at least some embodiments described herein. By way of example, the global rule may impose a restriction to prevent use of any image asset in a territory of North Korea in any format and any channel. The global rule is illustrated as a row 286 in FIG. 2D. The global rule may be applied to any image asset including the image asset 256 of FIGS. 2B and 2C. Thus, the image asset 256 of FIGS. 2B and 2C may be associated with an inherited right determined by the global rule.

FIG. 3A is an example flow diagram of a method 300 of performing asset rights clearance for an asset on a client side, arranged in accordance with at least some embodiments described herein. The method 300 may be performed in whole or in part by, e.g., any of the client devices 111 of FIG. 1. In some embodiments, the method 300 may be performed by the ARC application 121 embedded in the client application 119. Although illustrated as discrete blocks, various blocks may be divided into additional blocks, combined into fewer blocks, or eliminated, depending on the desired implementation.

The method 300 may begin at block 302 in which a web service call may be received from the client application 119. The web service call may include an asset clearance query associated with an asset. The query may be received as user input entered by a user through one or more I/O devices. The asset clearance query may inquire a use of the asset in a particular manner. For example, the asset clearance query may inquire whether an image may be used in a particular territory with a particular format during a particular time frame. The asset clearance query may include an identifier of the asset or assets and an intended use of the assets. The intended use of the assets may be defined by a combination of values of rights attributes and a time frame for the intended use. For example, the asset clearance query may include one or more asset IDs, one or more values for one or more rights attributes, an in date, and an out date.

The one or more values for the one or more rights attributes may be selectable from possible values in one or more hierarchical structures related to the one or more rights attributes. Each rights attribute may be associated with a hierarchical structure. In some embodiments, multiple values may be selected for a rights attribute so that multiple rights associated with the multiple values may be queried simultaneously. For example, the asset clearance query may include “USA” and “Mexico” for a rights attribute “territory” so that rights in the territories of USA and Mexico may be queried simultaneously.

In some embodiments, the asset clearance query may be received from the client device 111 (and/or from a corresponding I/O device) via a graphical user interface. For example, a user may input one or more asset IDs, one or more values for the one or more rights attributes, an in date, and/or an out date in the graphical user interface using one or more I/O devices. Alternatively, the asset clearance query may be generated automatically by the web service call.

At block 306, the web service call that may include the asset clearance query may be sent to the cloud-based rights clearance server 101. The rights clearance server 101 may process the asset clearance query by performing operations similar or identical to those of a method 350 described in FIG. 3B.

The rights clearance server 101 may return a response responsive to the asset clearance query. Accordingly, at block 308, the response may be received from the cloud-based rights clearance server 101. In some embodiments, the response may include an indication of an availability to use the asset in the particular manner. For example, the response may indicate that the asset may be used in the particular manner specified by the asset clearance query. Alternatively, the response may include an indication of a non-availability to use the asset in the particular manner. For example, the response may indicate that the asset may not be used in the particular manner. Alternatively, the response may include an indication of all permitted uses for the asset.

At block 310, the method 300 may include determining whether the response may include an indication of an availability to use the asset in the particular manner. If the response includes the indication of the availability to use the asset in the particular manner, the method 300 may proceed to block 312. Otherwise, the method 300 may proceed to block 314.

At block 312, the response that includes the indication of the availability to use the asset in the particular manner may be presented. For example, the response may be forwarded to the client application 119 and presented to the user.

At block 314, the response that includes an indication of a non-availability to use the asset in the particular manner may be presented. For example, the response may be forwarded to the client application 119 and presented to the user.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, responsive to receiving the response that includes the indication of the non-availability to use the asset in the particular manner, the method 300 may additionally include generating a request to use the asset in the particular manner and forwarding the request to a related entity or a related department in an organization (e.g., an acquisition department, a legal department, etc.). The related entity or department may obtain an approval (e.g., a license) to use the asset in the particular manner. Alternatively, the related entity or department may deny the request to use the asset in the particular manner. Alternatively or additionally, the method 300 may include providing a list of similar assets that may be used in the particular manner to the user, so that the user may select an asset from the list to be used in the particular manner.

In some embodiments, the method 300 may additionally include fulfilling one or more obligations upon use of the asset in the particular manner. An obligation may be related to a specific use of an asset, and may be tied to a specific available right that allows the asset to be used in a particular manner. Each available right may be associated with a single obligation or multiple obligations. The obligations may be accessed through an available right screen.

In some embodiments, the asset rights clearance may be performed for multiple assets simultaneously. The asset clearance query may include multiple asset IDs or asset names that may identify the multiple assets, so that whether the multiple assets may be used in a particular manner may be determined simultaneously by performing similar operations. A response may be received from the cloud-based rights clearance server 101, which may include one of: (1) an indication of an availability to use each of the multiple assets in the particular manner (e.g., AVAILABLE) if each of the multiple assets may be used in the particular manner; (2) an indication of a non-availability to use any of the multiple assets in the particular manner (e.g., NOT AVAILABLE) if each of the multiple assets may not be used in the particular manner; or (3) a first indication of an availability to use one or more first assets in the particular manner, and a second indication of a non-availability to use one or more second assets in the particular manner (e.g., AVAILABLE except: XYZ exceptions). The XYZ exceptions may include asset IDs to identify the one or more second assets that may not be used in the particular manner.

In some embodiments, similar operations may be performed to determine whether a single asset may be used in multiple particular manners. The asset clearance query may include different value combinations for the rights attributes, with each value combination related to a particular manner to use the asset. For example, the asset clearance query may include “print” and “web” for a rights attribute “format” for an image asset, so that the asset clearance query may be configured to inquire a print right and a web publication right of the image asset simultaneously. A response may be received from the cloud-based rights clearance server 101, which may include one of: (1) an indication of an availability to use the asset in the multiple particular manners (e.g., AVAILABLE) if the asset may be used in all of the multiple particular manners; (2) an indication of a non-availability to use the asset in each of the multiple particular manners (e.g., NOT AVAILABLE) if the asset may not be used in any of the multiple particular manners; or (3) a first indication of an availability to use the asset in one or more first particular manners of the multiple particular manners, and a second indication of a non-availability to use the asset in one or more second particular manners of the multiple particular manners (e.g., AVAILABLE except: XYZ exceptions). The XYZ exceptions may identify the one or more second particular manners associated with the non-availability.

Some embodiments disclosed herein include an article of manufacture such as a non-transitory computer storage medium having instructions stored thereon that are executable by a computing device to perform operations included in the method 300 of FIG. 3A, such as the operations illustrated by blocks 302, 306, 308, 310, 312, and/or 314 in FIG. 3A, and/or variations thereof. The non-transitory computer storage medium may be included in or may be accessible to one or more of the client devices 111 of FIG. 1. The computing device may include any of the client devices 111 and/or a processor or other processing device of the client devices 111 such as the processor 113.

FIG. 3B is a flow diagram of an example method 350 of performing asset rights clearance for an asset on a server side, arranged in accordance with at least some embodiments described herein. The method 350 may be performed in whole or in part by, e.g., the rights clearance server 101 of FIG. 1. Although illustrated as discrete blocks, various blocks may be divided into additional blocks, combined into fewer blocks, or eliminated, depending on the desired implementation.

The method 350 may begin at block 352 in which a web service call may be received from a client device 111 (e.g., from the ARC application 121 of the client device 111a). The web service call may include an asset clearance query associated with an asset. The asset clearance query may inquire a use of the asset in a particular manner.

At block 354, the asset registry 106 of FIG. 1 may be queried using the asset clearance query.

At block 356, the method 350 may include determining whether an availability to use the asset in the particular manner exists. For example, the rights clearance server 101 may query the asset registry 106 to determine whether the asset may be used in the particular manner. If the availability to use the asset in the particular manner exists, the method 350 may proceed to block 358. Otherwise, the method 350 may proceed to block 360.

At block 358, a response may be generated and sent to the client device 111. The response may include an indication of the availability to use the asset in the particular manner.

At block 360, a response may be generated and sent to the client device 111. The response may include an indication of a non-availability to use the asset in the particular manner.

In some embodiments, similar operations may be performed to simultaneously determine whether the asset may be used in multiple particular manners. The asset clearance query may include multiple value combinations for the rights attributes, with each value combination related to a particular manner to use the asset. The rights clearance server 101 may generate and send a response that may include one of: (1) an indication of an availability to use the asset in the multiple particular manners if the asset may be used in all of the multiple particular manners; (2) an indication of a non-availability to use the asset in each of the multiple particular manners if the asset may not be used in any of the multiple particular manners; or (3) a first indication of an availability to use the asset in one or more first particular manners of the multiple particular manners, and a second indication of a non-availability to use the asset in one or more second particular manners of the multiple particular manners.

In some embodiments, the asset rights clearance may be performed for multiple assets simultaneously. The cloud-based rights clearance server 101 may generate a response which may include one of: (1) an indication of an availability to use each of the multiple assets in the particular manner if each of the multiple assets may be used in the particular manner; (2) an indication of a non-availability to use any of the multiple assets in the particular manner if each of the multiple assets may not be used in the particular manner; or (3) a first indication of an availability to use one or more first assets in the particular manner, and a second indication of a non-availability to use one or more second assets in the particular manner.

Some embodiments disclosed herein include an article of manufacture such as a non-transitory computer storage medium having instructions stored thereon that are executable by a computing device to perform operations included in the method 350 of FIG. 3B, such as the operations illustrated by blocks 352, 354, 356, 358, and/or 360 in FIG. 3B, and/or variations thereof. The non-transitory computer storage medium may be included in or may be accessible to the rights clearance server 101 of FIG. 1. The computing device may include the rights clearance server 101 and/or a processor or other processing device of the rights clearance server 101 such as the processor 103.

Example uses of the method 300 of FIG. 3A and the method 350 of FIG. 3B may be provided herein with combined reference to FIGS. 2B-2D. As described above, the image asset 256 of FIGS. 2B and 2C may be associated with the available rights shown in FIG. 2B (e.g., print rights are available for the image asset 256 worldwide via all channels, and web publication rights are available for the image asset 256 in USA and France only via all channels), the restricted right shown in FIG. 2C (e.g., the image asset 256 may not be used in educational channels), and the global rule shown in FIG. 2D (e.g., any image asset may not be used in a territory of North Korea with any format and any channel).

In a first example, a user may want to know whether the image asset 256 may be used in a commercial magazine to be published in the USA, Canada, and Mexico in December 2014. The user may input an asset clearance query that includes: asset ID=1234; format=print; territory=USA, Canada, Mexico; channel=null; in date=Dec. 1, 2014; and out date=Dec. 31, 2014. The asset clearance query may be sent to the rights clearance server 101. In some embodiments, the user may manually input the asset clearance query via a screen. Alternatively, a web service call that includes the asset clearance query may be issued.

The rights clearance server 101 may check the asset registry 106 of FIG. 1 to determine whether the image asset 256 may be used in the commercial magazine in a manner specified by the asset clearance query. Since the image asset 256 has print rights available worldwide (other than in North Korea) through Dec. 31, 2014 and is not used in an educational channel constrained by the restricted right, the rights clearance server 101 may generate and return a response that includes an indication of an availability to use the image asset 256 in the commercial magazine to be published in the USA, Canada, and Mexico in December 2014.

In a second example, the user may want to know whether the image asset 256 may be used on a web site hosted in Mexico in December, 2014. The user may input an asset clearance query that includes: asset ID=1234; format=web; territory=Mexico; channel=null; in date=Dec. 1, 2014; and out date=Dec. 31, 2014. The asset clearance query may be sent to the rights clearance server 101. The rights clearance server 101 may check the asset registry 106 of FIG. 1 to determine whether the image asset 256 may be used on the web site in Mexico. Since the image asset 256 has web publication rights only available in USA and France as indicated in FIG. 2B, the rights clearance server 101 may generate and return a response that includes an indication of a non-availability to use the image asset 256 on the web site in Mexico.

Optionally, a request to use the image asset 256 on the web site in Mexico may be sent to a related entity responsive to the non-availability. The related entity may obtain a license to use the image asset 256 on the web site in Mexico for the user. Alternatively, the related entity may instruct the user to select another image for the intended use rather than using the image asset 256. In some embodiments, one or more other image assets that may be used on the web site in Mexico may be presented to the user so that the user may select one image asset from the one or more other image assets.

In a third example, the user may want to know whether the image asset 256 may be used on web sites in the USA, Canada, and Mexico in December 2014. The user may input an asset clearance query that includes: asset ID=1234; format=web; territory=USA, Canada, Mexico; channel=null; in date=Dec. 1, 2014; and out date=Dec. 31, 2014. The rights clearance server 101 may check the asset registry 106 of FIG. 1 to determine whether the image asset 256 may be used on the web sites in the USA, Canada, and Mexico. Since the image asset 256 has web publication rights only available in USA and France as indicated in FIG. 2B, the rights clearance server 101 may generate and return a response that includes: a first indication of an availability to use the image asset 256 on a web site in the USA; and a second indication of a non-availability to use the image asset 256 on web sites in Canada and Mexico. For example, the response may include “available except: web/Canada, web/Mexico.”

In a fourth example, the user may want to know whether the image asset 256 may be used in an educational magazine to be published in the USA and France in December 2014. The user may input an asset clearance query that includes: asset ID=1234; format=null; territory=USA, France; channel=educational; in date=Dec. 1, 2014; and out date=Dec. 31, 2014. The rights clearance server 101 may check the asset registry 106 of FIG. 1 to determine whether the image asset 256 may be used in the educational magazine. Since the image asset 256 may not be used in an educational channel as indicated by the restricted right of FIG. 2C, the rights clearance server 101 may generate and return a response that includes an indication of a non-availability to use the image asset 256 in the educational magazine.

In a fifth example, the user may want to know whether the image asset 256 may be used on web sites in the USA, France, and North Korea in December 2014. The user may input an asset clearance query that includes: asset ID=1234; format=web; territory=USA, France, North Korea; channel=null; in date=Dec. 1, 2014; and out date=Dec. 31, 2014. The rights clearance server 101 may check the asset registry 106 of FIG. 1 to determine whether the image asset 256 may be used on web sites in the USA, France, and North Korea. Since the image asset 256 may be used on web sites in the USA and France as indicated in FIG. 2B and may not be used in North Korea as indicated by the global rule of FIG. 2D, the rights clearance server 101 may generate and return a response that includes: (1) a first indication of an availability to use the image asset 256 on web sites in the USA and France; and (2) a second indication of a non-availability to use the image asset 256 in North Korea. For example, the response may include “available except: web/North Korea.”

Other example asset clearance queries are possible. In these and other examples, one or more obligations may be associated with the image asset 256. For example, if the image asset 256 is used for commercial purposes, an obligation may exist to send a notification to a creator of the image asset 256. In another example, if the image asset 256 is used internationally, an obligation may exist to pay a $500 fee to the creator of the image asset 256.

Accordingly, the methods 300, 350 of FIGS. 3A and 3B may be used to inquire whether one or more assets specified in a query may be used in one or more particular manners specified in the query.

FIG. 4A is a flow diagram of an example method 400 of performing a rights query on a client side, arranged in accordance with at least some embodiments described herein. The method 400 may be performed in whole or in part by, e.g., the client device 111 of FIG. 1. For example, the method 400 may be performed by the ARC application 121 of FIG. 111a. Although illustrated as discrete blocks, various blocks may be divided into additional blocks, combined into fewer blocks, or eliminated, depending on the desired implementation.

The method 400 may begin at block 402 in which a web service call may be received from the client application 119. The web service call may include a rights query that may specify one or more rights conditions for assets to satisfy. In some embodiments, a user may input the rights query via a graphical user interface. The rights query may include a combination of an asset name, an asset type, an asset ID, other asset metadata, values for one or more rights attributes, a rule type (e.g., an available right or a restricted right), an in date, and/or an out date. In some embodiments, the one or more rights conditions may include an available right, a restricted right, a global rule, or a combination thereof to be satisfied by assets in a search result.

At block 404, the web service call may be sent to the cloud-based rights clearance server 101 of FIG. 1. The rights clearance server 101 may determine one or more assets that satisfy the one or more rights conditions by performing operations similar or identical to those of a method 450 in FIG. 4B.

At block 406, a response that includes the one or more assets satisfying the one or more rights conditions may be received from the rights clearance server 101. An example response is illustrated in FIG. 4C.

At block 408, the one or more assets that satisfy the one or more rights conditions, or a list of the one or more assets, may be presented to the user. Alternatively, the one or more assets, or the list of the one or more assets, may be returned to the client application 119 on the client device 111.

Some embodiments disclosed herein include an article of manufacture such as a non-transitory computer storage medium having instructions stored thereon that are executable by a computing device to perform operations included in the method 400 of FIG. 4A, such as the operations illustrated by blocks 402, 404, 406, and/or 408 in FIG. 4A, and/or variations thereof. The non-transitory computer storage medium may be included in or may be accessible to the client device 111 of FIG. 1. The computing device may include the client device 111 and/or a processor or other processing device of the client device 111 such as the processor 113.

FIG. 4B is a flow diagram of an example method 450 of performing a rights query on a server side, arranged in accordance with at least some embodiments described herein. The method 450 may be performed in whole or in part by, e.g., the rights clearance server 101 of FIG. 1. Although illustrated as discrete blocks, various blocks may be divided into additional blocks, combined into fewer blocks, or eliminated, depending on the desired implementation.

The method 450 may begin at block 452 in which a web service call may be received from the client device 111 (e.g., the ARC application 121 on the client device 111a). The web service call may include a rights query that may specify one or more rights conditions.

At block 454, the asset registry 106 of FIG. 1 may be queried using the rights query to determine one or more assets that satisfy the one or more rights conditions.

At block 456, a response that includes the one or more assets and/or a list of the one or more assets may be sent to the client device 111.

Some embodiments disclosed herein include an article of manufacture such as a non-transitory computer storage medium having instructions stored thereon that are executable by a computing device to perform operations included in the method 450 of FIG. 4B, such as the operations illustrated by blocks 452, 454, and/or 456 in FIG. 4B, and/or variations thereof. The non-transitory computer storage medium may be included in or may be accessible to the rights clearance server 101 of FIG. 1. The computing device may include the rights clearance server 101 and/or a processor or other processing device of the rights clearance server 101 such as the processor 103.

FIG. 4C is a graphic representation 470 that illustrates an example response that includes an asset satisfying a rights condition, arranged in accordance with at least some embodiments described herein. For example, the rights condition may include a restricted right that may constrain use of images in North Korea. An image asset with an asset ID 1234 may satisfy the rights condition and may be shown in a row 472 of the response.

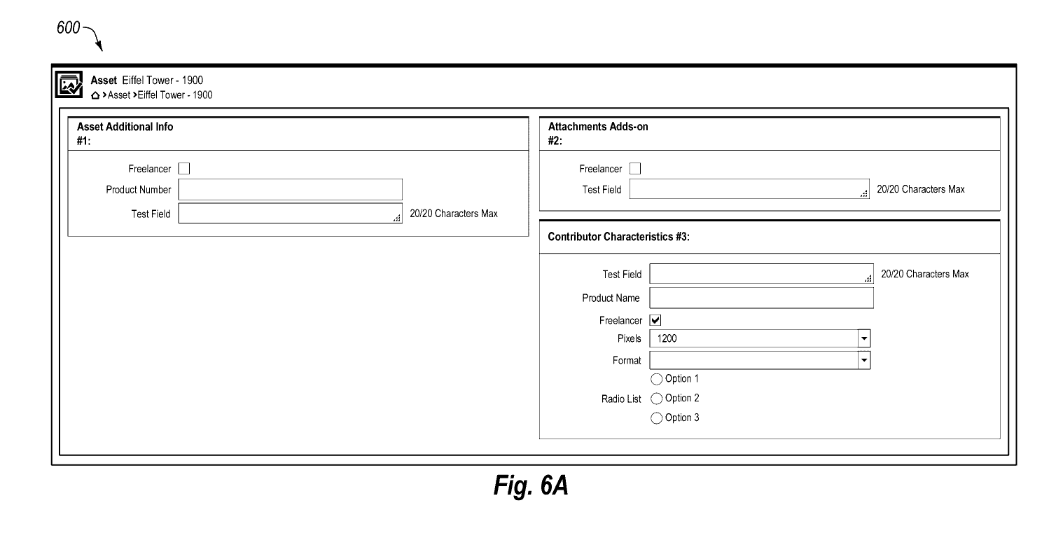

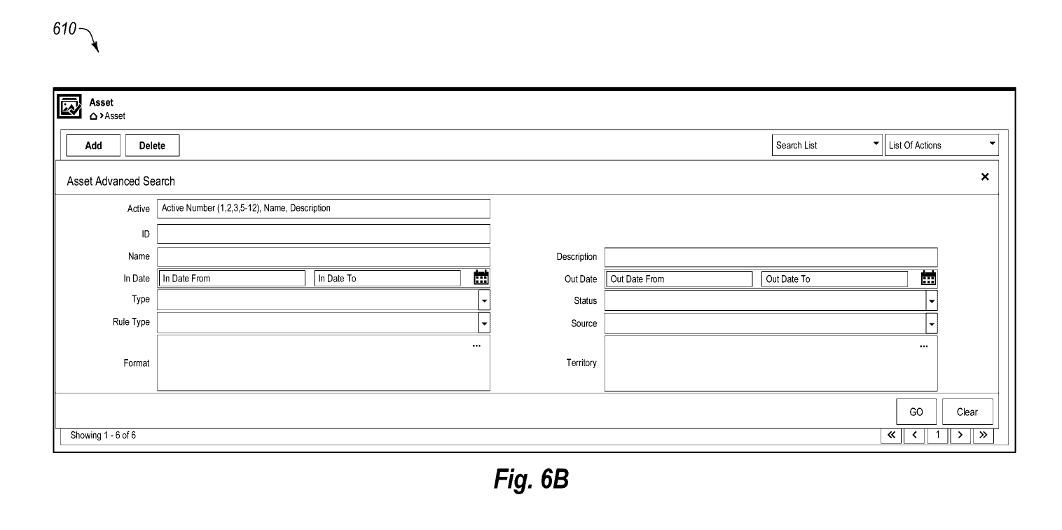

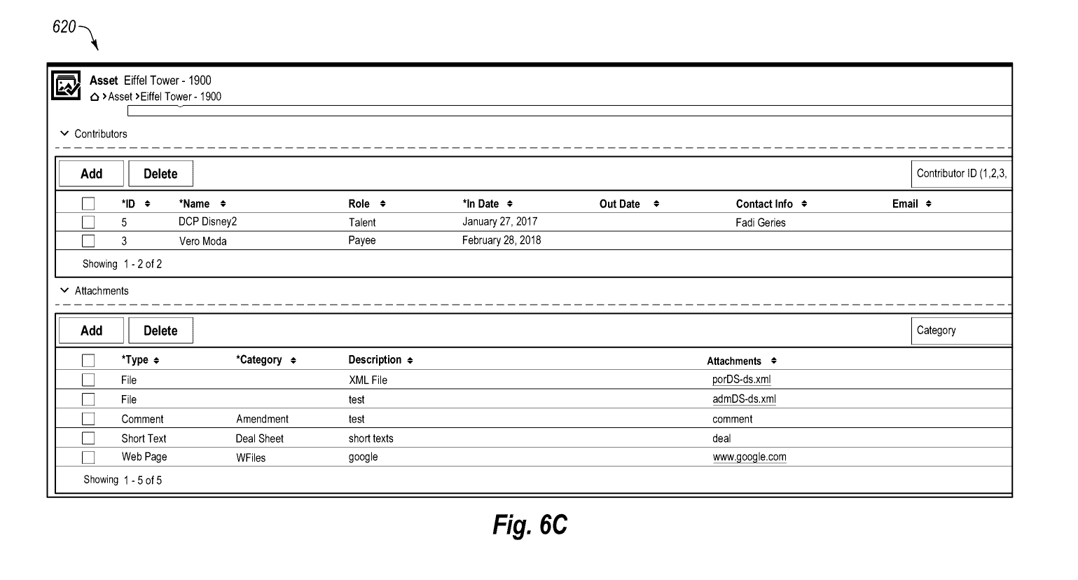

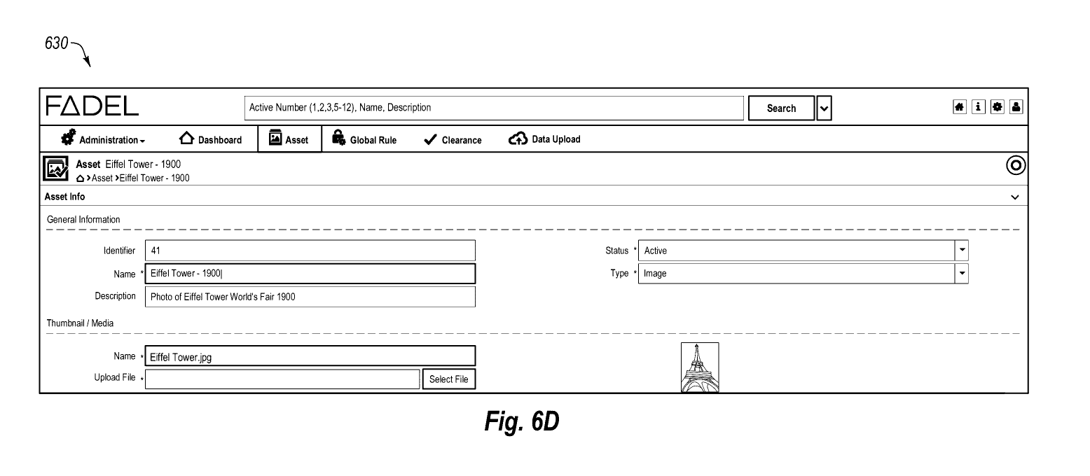

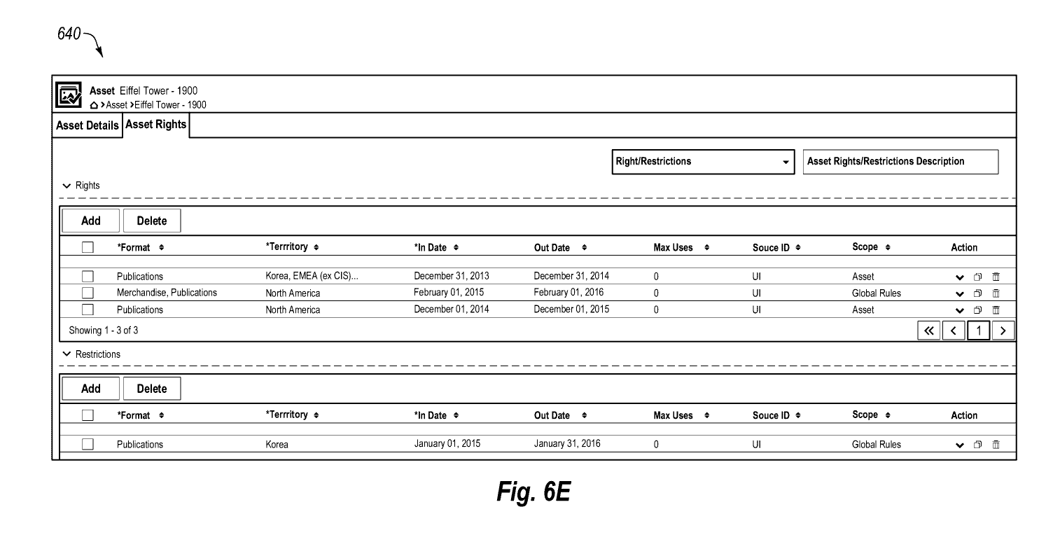

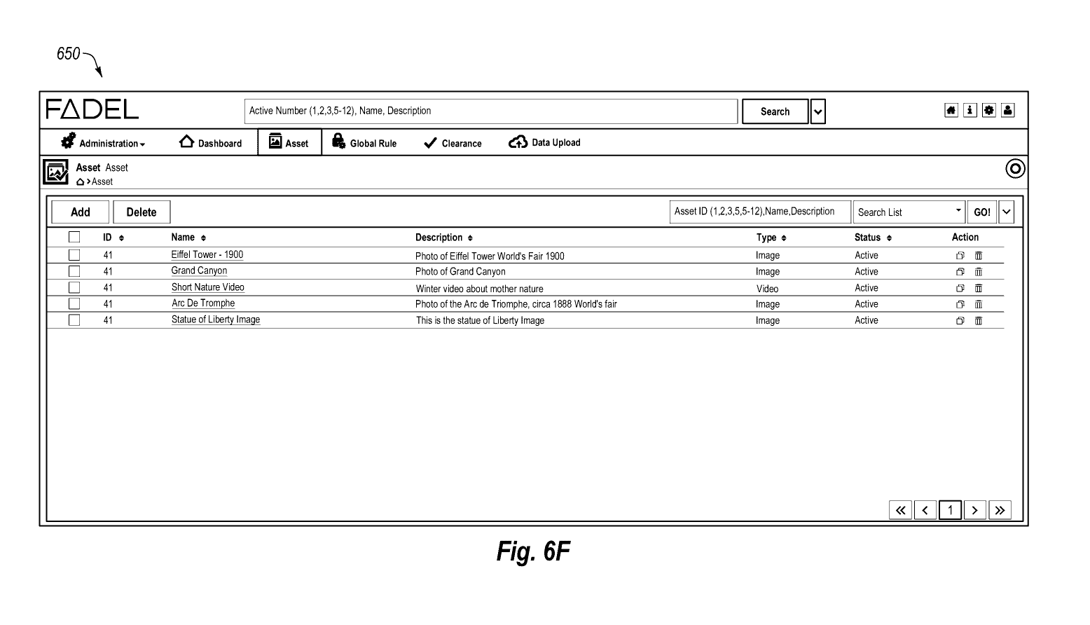

FIGS. 6A-6F are graphic representations 600, 610, 620, 630, 640, and 650 that illustrate various example user interfaces for managing assets and performing asset rights clearance, arranged in accordance with at least some embodiments described herein. FIG. 6A includes a user interface configured for adding additional information, attachments, and contributor information to an asset. FIG. 6B includes a user interface configured for an asset search. FIG. 6C includes a user interface configured to show contributors and attachments associated with an asset. FIG. 6D includes a user interface configured to add information to an asset. FIG. 6E includes a user interface configured to show available rights and restricted rights associated with an asset. FIG. 6F includes a user interface configured to list various assets.

Other example user interfaces may be provided herein. For example, in some embodiments, an administration menu may be provided in a dashboard screen so that a user with appropriate authority may access a list of administration tools including, but not limited to, a user management tool, a role management tool, a common lookup tool, a profile option tool, a job management tool, a status tool, a metadata management tool, a rights management tool, a workflow tool, a global rule setup tool, a data upload tool, a rights attribute service tool, and/or a tool for managing deployment modes.

The user management tool may be configured to manage user definitions and metadata. The user management tool may be integrated with single sign-on or other authorization mechanisms such as OpenID, lightweight directory access protocol (LDAP), or active directory (AD).

The role management tool may allow users to be assigned to different roles, which may determine and/or limit their access to different functionality and/or different data. The common lookup tool may allow administrators with appropriate access to manage values associated with numerous lookups. The profile option tool may allow administrators to configure and/or set up profile options. The job tool may be used to define and/or schedule automated jobs that may run in the background for accomplishing data management and/or other automated system tasks. The status tool may allow tracking asset statuses. The metadata management tool may allow users to define various types of metadata fields and associate them with different asset types.

The rights management tool may allow users to manage various rights attributes as well as values for the various rights attributes. For example, the rights management tool may be used to configure a total number of rights attributes to be employed, names of the rights attributes, a hierarchical structure of each rights attribute (e.g., a number of levels in a tree-like hierarchical structure, categories, groupings), and/or values for each level in the hierarchical structure of each rights attribute (e.g., a value for a node in a top level, values for nodes in a middle level, values for nodes in a bottom level, etc.).

The global rule setup tool may allow administrators with appropriate access authority to specify one or more rights attributes applied in a global rule. As described above, assets may be associated with specific rights and/or restrictions, and may also inherit rights and/or restrictions from global rules. A global rule may be applied to assets of a particular type or condition, such as asset metadata. The global rule may be defined by one or more of an asset type, one or more values for one or more rights attributes, an in date, an out date, a rule type, a source ID, and/or other fields. The rule type may determine whether an inherited right defined by the global rule may be an available right or a restricted right. For example, if the rule type includes an available type, an inherited right defined by the global rule may be classified to an available right. If the rule type includes a restriction type, an inherited right defined by the global rule may be classified to a restricted right.

The data upload tool may be configured for uploading asset data, rights data, and/or usage data to the rights clearance server 101 of FIG. 1. Each data upload may be implemented using a web service such as an extensible markup language (XML) call or JavaScript object notation (JSON), an administrative upload (e.g., spreadsheet/csv upload), and/or on-screen manual data entry.

An asset data upload may include uploading an asset name, an asset description, an asset ID, an asset type, an asset status, and/or other asset metadata.

A rights data upload may include uploading an asset ID, one or more rights attributes, values for the one or more rights attributes, an in date, an out date, a max use count, a rule type, and/or a source ID. After upload, the rights data may be analyzed and associated with corresponding assets in the asset registry 106 of FIG. 1. For example, the rights data may be maintained in a data structure similar to those of FIGS. 2B and 2C.

A usage data upload may include specifying a max use count and/or a used count associated with a particular asset and a particular combination of one or more values for one or more rights attributes. For example, a max use count may describe a maximum number of uses for an asset in a particular format, a particular territory, and/or a particular channel. A usage data upload may include uploading an asset ID, one or more rights attributes, values for the one or more rights attributes, an in date, an out date, and a number of uses.

The rights attribute service tool may allow users and/or other applications to obtain a list of active rights attributes used currently. A rights attribute service may deliver data sets for asset types, asset IDs, asset names, one or more rights attributes, asset statuses, and/or other data. The rights attribute service may be called from a web service or integrated with a third-party application. In some embodiments, an asset clearance query and/or a rights query may be called from services or external applications. The rights attribute service may provide users with the one or more rights attributes (e.g., format, territory, channel, etc.) and values for each of the right attributes, so that the users may specify the asset clearance query and/or the rights query through selecting values for the rights attributes.

In some embodiments, an asset details page may include an associated contract tab through which a user may associate an asset with contract information. An asset may be associated with multiple contracts (e.g., contracts with a photographer, a producer, a talent, a release holder, etc.). The contract information may include a contract name, a contract number or ID, a contract description, a contract type, a contract party, a contract start date, a contract end date, and/or a contract status. In some embodiments, the contract information may be inputted manually on a screen. Alternatively, the contract information may be uploaded through a web service (e.g., XML call or JSON) or an administrative upload via spreadsheet.

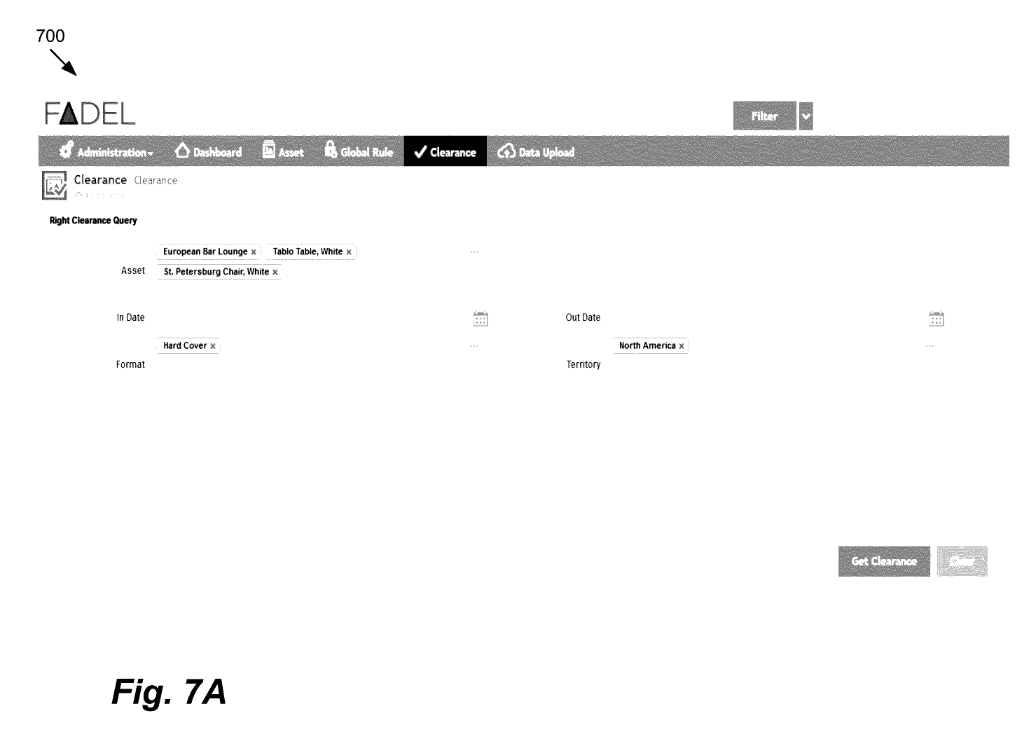

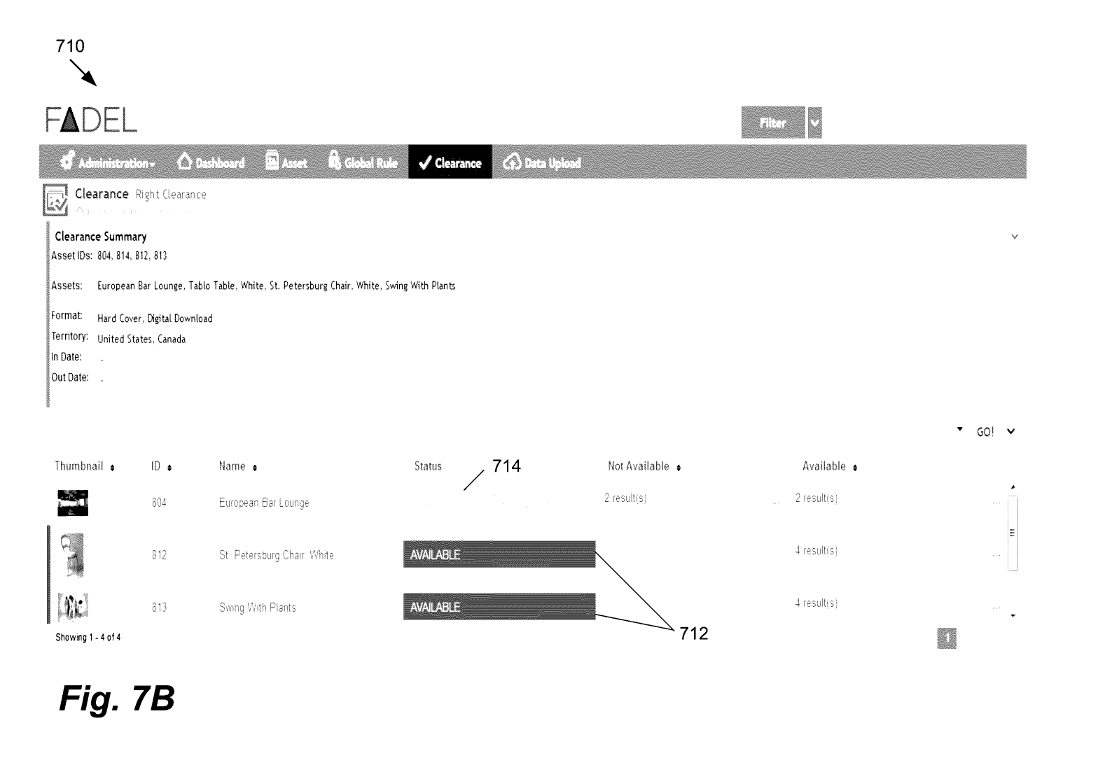

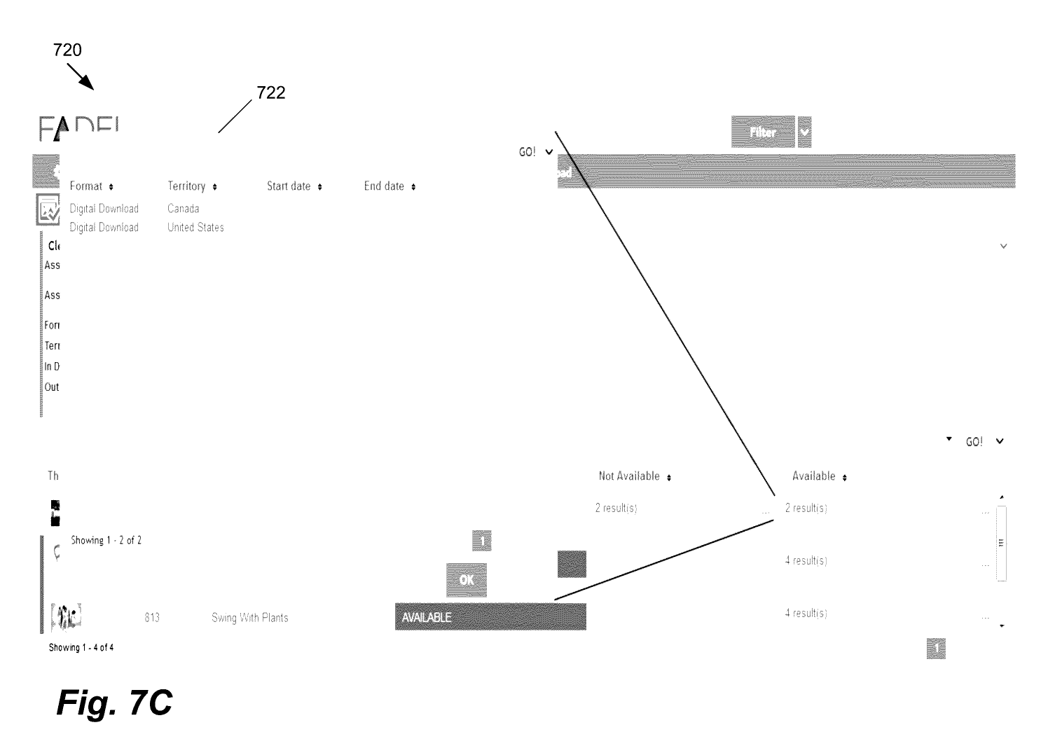

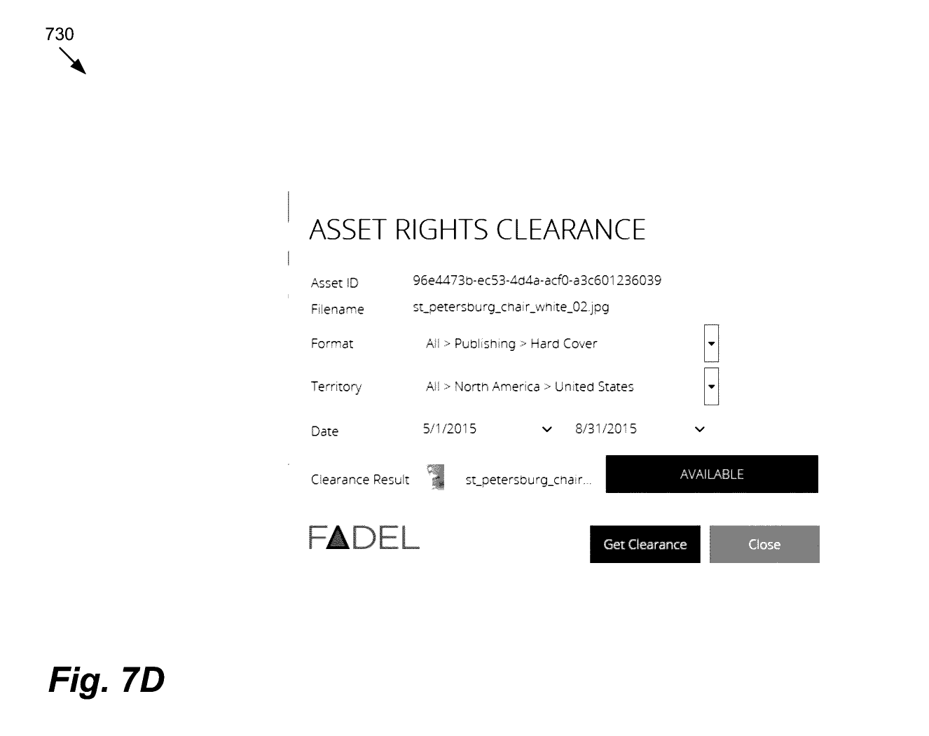

FIG. 7A is a graphic representation 700 that illustrates an example user interface for configuring an example asset rights clearance query, arranged in accordance with at least some embodiments described herein. FIG. 7B is a graphic representation 710 that illustrates an example user interface that shows an example clearance result, arranged in accordance with at least some embodiments described herein. The clearance result may use green labels to highlight assets with an available clearance result (e.g., labels 712), yellow labels to highlight assets with an available clearance result plus exceptions (e.g., a label 714), and red labels to highlight assets with a non-available clearance result. The available clearance result plus exceptions marked by the yellow label 714 may be viewed through a pop-up 722 shown in a graphic representation 720 of FIG. 7C. FIG. 7D is a graphic representation 730 that illustrates an integrated widget example of asset rights clearance, arranged in accordance with at least some embodiments described herein. The widget example may be integrated with a DAM search or another suitable third-party application.

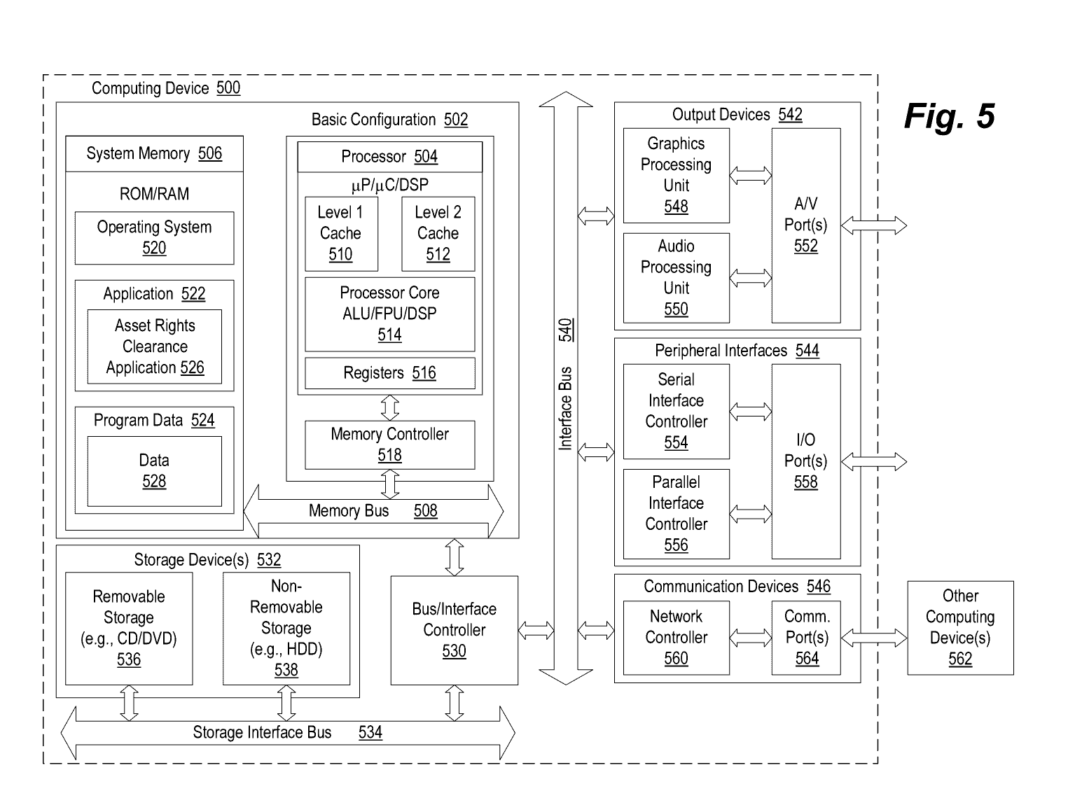

FIG. 5 is a block diagram that illustrates an example computing device 500 that is arranged for asset rights clearance, in accordance with at least some embodiments described herein. The computing device 500 may be included in or correspond to any of the client devices 111, and/or the rights clearance server 101 of FIG. 1, for example. In a very basic configuration 502, the computing device 500 may typically include one or more processors 504 and a system memory 506. A memory bus 508 may be used for communicating between the processor 504 and the system memory 506.

Depending on the desired configuration, the processor 504 may be of any type including, but not limited to, a CPU, a μP, a μC, a DSP, or any combination thereof. The processor 504 may include one or more levels of caching, such as a level one cache 510 and a level two cache 512, a processor core 514, and registers 516. The example processor core 514 may include an arithmetic logic unit (ALU), a floating point unit (FPU), a digital signal processing core (DSP core), or any combination thereof. An example memory controller 518 may also be used with the processor 504, or in some implementations the memory controller 518 may be an internal part of the processor 504.

Depending on the desired configuration, the system memory 506 may be of any type including, but not limited to, volatile memory (such as RAM), non-volatile memory (such as ROM, flash memory), or any combination thereof. The system memory 506 may include an operating system (OS) 520, one or more applications 522, and program data 524. The application 522 may include an asset rights clearance application 526, an app, an application server, or other application that may be arranged to perform one or more of the functions as described herein including those described with respect to the methods 300, 350, 400, and 450 of FIGS. 3A-3B and 4A-4B. The program data 524 may include data 528 such as rights data and asset data. In some embodiments, the application 522 may be arranged to operate with the program data 524 on the OS 520 such that implementations of methods for performing asset rights clearance and rights queries, such as the methods 300, 350, 400, and 450 of FIGS. 3A-3B and 4A-4B, may be provided as described herein.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

The system memory 506, removable storage devices 536, and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via the bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device) or other peripheral devices (e.g., printer, scanner) via one or more I/O ports 558. The example communication device 546 may include a network controller 560, which may be arranged to facilitate communications with one or more other computing devices 562 over a network communication link via one or more communication ports 564.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 500 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a processor; and
a non-transitory computer-readable storage medium that stores a rights clearance application that is embedded in a client application, wherein in response to execution by the processor the rights clearance application is configured to:
receive a first web service call from the client application, the first web service call including an asset clearance query associated with an asset, wherein the asset clearance query inquires a use of the asset in one or more manners;
send the first web service call to a cloud-based rights clearance server;
receive a response from the cloud-based rights clearance server;
determine that the response includes an indication of an availability to use the asset in a first manner of the one or more manners; and
forward data that describes the availability to use the asset in the first manner to the client application.

2. The system of claim 1, wherein in response to execution by the processor the rights clearance application is further configured to:
receive a second web service call from the client application, the second web service call including a rights query that specifies one or more rights conditions for assets to satisfy;
send the second web service call to the cloud-based rights clearance server;
receive data that describes one or more assets that satisfy the one or more rights conditions from the cloud-based rights clearance server; and
forward the data that describes the one or more assets to the client application.

3. The system of claim 2, wherein:
the rights query includes at least one of a value for a rule type, one or more values for one or more rights attributes, or a time frame determined by an in date and an out date; and
the at least one of the value for the rule type, the one or more values for the one or more rights attributes, or the time frame specifies the one or more rights conditions.

4. The system of claim 1, wherein:
the asset clearance query includes one or more values for one or more rights attributes; and
the one or more values for the one or more rights attributes determines the use of the asset in the one or more manners.

5. The system of claim 1, wherein in response to execution by the processor the rights clearance application is further configured to:
determine that the response includes an indication of a non-availability to use the asset in a second manner of the one or more manners; and
forward data that describes the non-availability to use the asset in the second manner to the client application.

6. A cloud-based rights clearance computing device, the computing device comprising:
a processor; and
a non-transitory computer-readable storage medium storing instructions that, in response to execution by the processor, cause the processor to perform operations comprising:
receiving a first web service call that includes an asset clearance query associated with an asset from a client device, the asset clearance query configured to inquire a use of the asset in one or more manners;
querying an asset registry using the asset clearance query to determine an availability to use the asset in a first manner of the one or more manners; and
sending a response that includes an indication of the availability to use the asset in the first manner.

7. The cloud-based rights clearance computing device of claim 6, wherein the operations further comprise:
receiving a second web service call from the client device, the second web service call including a rights query that includes one or more rights conditions for assets to satisfy;
querying the asset registry using the rights query to determine one or more assets that satisfy the one or more rights conditions; and
sending data that describes the one or more assets to the client device.

8. The cloud-based rights clearance computing device of claim 7, wherein:
the rights query includes at least one of a value for a rule type, one or more values for one or more rights attributes, or a time frame determined by an in date and an out date; and
the at least one of the value for the rule type, the one or more values for the one or more rights attributes, or the time frame specifies the one or more rights conditions.

9. The cloud-based rights clearance computing device of claim 8, wherein the value for the rule type includes one of an available type and a restriction type.

10. The cloud-based rights clearance computing device of claim 6, wherein:
the asset clearance query includes one or more values for one or more rights attributes; and
the one or more values for the one or more rights attributes describes the use of the asset in the one or more manners.

11. The cloud-based rights clearance computing device of claim 6, wherein the operations further comprise:
querying the asset registry using the asset clearance query to determine a non-availability to use the asset in a second manner of the one or more manners,
wherein the response further includes an indication of the non-availability to use the asset in the second manner.

12. A method for asset rights clearance, the method comprising:
receiving an asset clearance query associated with an asset, wherein the asset clearance query inquires a use of the asset in one or more manners;
sending the asset clearance query to a cloud-based rights clearance server;
receiving a response from the cloud-based rights clearance server;
determining that the response includes an indication of an availability to use the asset in a first manner of the one or more manners; and
presenting the indication of the availability to use the asset in the first manner.

13. The method of claim 12, further comprising:
receiving a rights query that includes one or more rights conditions for assets to satisfy;
sending the rights query to the cloud-based rights clearance server;
receiving data that describes one or more assets that satisfy the one or more rights conditions from the cloud-based rights clearance server; and
presenting the data that describes the one or more assets.

14. The method of claim 13, wherein:
the rights query includes at least one of a value for a rule type, one or more values for one or more rights attributes, or a time frame; and
the at least one of the value for the rule type, the one or more values for the one or more rights attributes, or the time frame specifies the one or more rights conditions.

15. The method of claim 12, further comprising:
determining that the response includes an indication of a non-availability to use the asset in a second manner of the one or more manners; and
presenting the indication of the non-availability to use the asset in the second manner.

16. A method for asset rights clearance, the method comprising:
receiving an asset clearance query associated with an asset from a client device, wherein the asset clearance query inquires a use of the asset in one or more manners;
querying an asset registry using the asset clearance query to determine an availability to use the asset in a first manner of the one or more manners; and
sending a response that includes an indication of the availability to use the asset in the first manner.

17. The method of claim 16, further comprising:
receiving from the client device a rights query that includes one or more rights conditions for assets to satisfy;
querying the asset registry using the rights query to determine one or more assets that satisfy the one or more rights conditions; and
sending data that describes the one or more assets to the client device.

18. The method of claim 17, wherein:
the rights query includes at least one of a value for a rule type, one or more values for one or more rights attributes, or a time frame; and
the at least one of the value for the rule type, the one or more values for the one or more rights attributes, or the time frame specifies the one or more rights conditions.

19. The method of claim 18, wherein the value for the rule type includes one of an available type and a restriction type.

20. The method of claim 16, further comprising:
querying the asset registry using the asset clearance query to determine a non-availability to use the asset in a second manner of the one or more manners,
wherein the response further includes an indication of the non-availability to use the asset in the second manner.
